(19) United States
(12) Patent Application Publication
(10) Pub. No.: US 2005/0044763 A1
(43) Pub. Date: Mar. 3, 2005

(54) Systems and methods for progressive recognition elements

(76) Inventor: Alan Dean Smith, New Braunfels, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/649,003

(22) Filed: Aug. 26, 2003

(51) Int. Cl. G09F 7/00

(52) U.S. Cl. 40/605

(57) ABSTRACT

A system and method for presenting at least two recognition elements to represent a progressive or cumulative achievements. The recognition elements may be awarded to an individual, group, or team. The recognition elements may be in numerous shapes, sizes, and materials. The recognition elements may have textual recognition (such as markings, engravings, and embossing) on one or more surfaces of the recognition element. The recognition elements may be marked, engraved, and embossed with a combination of text, symbols, figures, and/or images. The recognition elements may be placed together to form predetermined forms or may be arranged by a recipient of the recognition elements into various forms. In addition, the recognition elements may be placed in a retention structure. The retention structure may be expandable.

### BACKGROUND OF THE INVENTION

1. Field of the Invention

The present invention generally relates to systems and methods for awards and recognitions. More particularly, the present invention relates to systems and methods for cumulative awards and recognitions.

2. Description of the Related Art

Awards are often used to recognize the achievements of an individual, group, or team. An award such as a trophy, plaque, or ribbon may be given in recognition of achievements and various other distinctions (e.g., good grades, athletic accomplishments, and work project completions). Individual recipients of the award may display their award in a location where others may see it (e.g., a trophy case). Awards given to a group or team may also be displayed in a location for others to see (such as a school trophy case). Individuals, groups, and teams may be awarded additional awards. While these awards may be placed near previous awards, a cumulative relationship between the awards, if one exists, will not be readily apparent. For example, trophies won by a single individual standing next to each other may not have a cumulative association apparent between them. While it may be apparent that both trophies may be related (e.g., both may have a basketball player on top), a cumulative association (e.g., one trophy for a divisional championship and one for a regional championship) may not be apparent without closer inspection. In the same way, ribbons or plaques awarded to an individual, group, or team may be displayed near each other, but a cumulative relationship may not be apparent between the ribbons or plaques

### SUMMARY OF THE INVENTION

In various embodiments, recognition elements may be used to recognize cumulative achievements. In some embodiments, recognition elements may be three-dimensional shapes that are used to form combined recognition structures. In various embodiments, numerous materials may be used for the recognition elements, and the recognition elements may be marked, engraved, or embossed to recognize an accomplishment, event, or recipient. For example, the recognition elements may be marked, engraved, or embossed with text, symbols (e.g., company logos), figures, and/or images (e.g., images of people or objects).

In various embodiments, the recognition elements may interact with other recognition elements to recognize a cumulative achievement. In some embodiments, the recognition elements may be stacked horizontally and/or vertically. In various embodiments, the horizontal and/or vertical interaction of the recognition elements may be assisted by the use of retention structures to provide support of the recognition elements. In various embodiments, numerous materials may be used for the retention structures, and the retention structures may support the interaction of recognition elements in a combined recognition structure. Retention structures may be marked, engraved, or embossed to recognize the accomplishment, event, or recipient.

Recognitions are often not tied to a solitary event or accomplishment. Accomplishments may build in a cumulative fashion from progressive events over time. These progressive accomplishments may build upon each other over time and combine to bring forth even larger and more impressive accomplishments. In various embodiments, recognition elements may recognize and physically award individuals, teams, and workgroups for progressive and cumulative accomplishments.

In various embodiments, recognition elements may use synergism. The cooperative (stacking and juxtaposition) action of the recognition elements is such that the total effect of a combined recognition structure using the recognition elements is greater then the sum of the effect of each individual recognition element taken independently. In some embodiments, as the recipient of recognition elements accumulates the recognition elements over time, the recipient may synthesize a combined recognition structure that increases in size and presence to embody a cumulative accomplishment greater then the independent recognition events. In some embodiments, the nature of the final synergistically combined recognition structure may reflect the collected accomplishments of a career or the combined impact of a multistage project.

In various embodiments, the recognition elements may be arranged in a dynamic combined recognition structure that the recipient can alter in shape and appearance over time. In various embodiments, the recipient of the recognition elements may have full flexibility and discretion in the placement of the recognition elements and their rearrangement at any time they so desire. In various embodiments, the recipient may remove and/or add recognition elements in their possession, as they desire. In various embodiments, the recipient may express their personal interest and taste in the appearance of their combined recognition structure formed out of recognition elements. In some embodiments, the recognition elements may be placed in a predetermined form. In various embodiments, the combined recognition structure may grow over time as additional recognition elements are awarded.

In various embodiments, the recognition elements and/or retention structures may be selected and/or presented to a recipient. In some embodiments, a second recognition element, retention structure, or both may be presented to the recipient. In various embodiments, the recipient may arrange the two or more recognition elements to create a combined recognition structure of their liking. In some embodiments, the recognition elements may be placed in a predetermined form. In various embodiments, additional recognition elements may be added.

### BRIEF DESCRIPTION OF THE DRAWINGS

Advantages of the present invention may become apparent to those skilled in the art with the benefit of the following detailed description of the preferred embodiments and upon reference to the accompanying drawings in which:

FIGS. 1a and 1b illustrate embodiments using square recognition elements.

FIGS. 2a and 2b illustrate additional embodiments using square recognition elements.

FIGS. 3a, 3b, and 3c illustrate recognition elements for a predetermined shape in the form of a pyramid.

FIG. 4 illustrates different shaped recognition elements for assembling a predetermined form.

FIGS. 5a and 5b illustrate an embodiment for cylindrical recognition elements using a retention structure.

FIGS. 6a and 6b illustrate an embodiment using cylindrical recognition elements using rods and pegs with a central support as a retention structure.

FIGS. 7a and 7b illustrate an embodiment using square recognition elements on a tilted retention structure.

FIG. 8 illustrates an embodiment of a method for presenting recognition elements.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

In various embodiments, individual contributors, teams, and work groups may be recognized and rewarded using a recognition element, made of any material and in any shape, that is designed to be an addition to a collection of recognition elements. In some embodiments, the recognition elements may be marked, engraved, or embossed on one or multiple surfaces to indicate the nature of the event being recognized. In some embodiments, the recognition elements may be designed for stacking in a horizontal direction, vertical direction, or both with other recognition elements. The stacked recognition elements may be self-standing. In various embodiments, a retention structure may be used to provide vertical support, horizontal support, or both to allow progressive growth of a collection of recognition elements. In some embodiments, the retention structure may be self-standing on a horizontal surface, mounted on a vertical surface, or supported from above. Other retention structure supports are also contemplated. In some embodiments, the retention structure may define vertical limits, horizontal limits, or both for the collection of recognition elements. In an embodiment, the retention structure or cumulative shape of the collection of recognition elements may define a set of external dimensions to allow recognition elements of different materials, shapes, and markings to be used in the same collection of recognition elements. In some embodiments, the final shape of the collection of retention elements may be known from the start of the recognition process. For example, there may be a predetermined number of recognition elements in the final shape. In addition, several sets of external dimensions may be used in the same collection of recognition elements. In some embodiments, the final shape of the collection of retention elements may not be known. For example, the recognition elements may be arranged in numerous shapes arbitrarily.

In various embodiments, the recognition elements may be presented to an individual contributor, team, or work group. The recognition elements may be arranged by the individual contributor, team, or work group in such a way as to create a collection of recognition elements that may be accumulated over time to create a progressive representation and expression of recognition and accomplishment for the individual, team, or group. In some embodiments, the progressive representation may expand in a horizontal direction, vertical direction, or both. The collection of recognition elements may start with a single recognition element and grow over time as additional recognition elements are added. In various embodiments, the recognition elements and/or retention structure may be personalized for the individual contributor, team, and/or work group that will receive the recognition element. In some embodiments, the recognition elements may be blank.

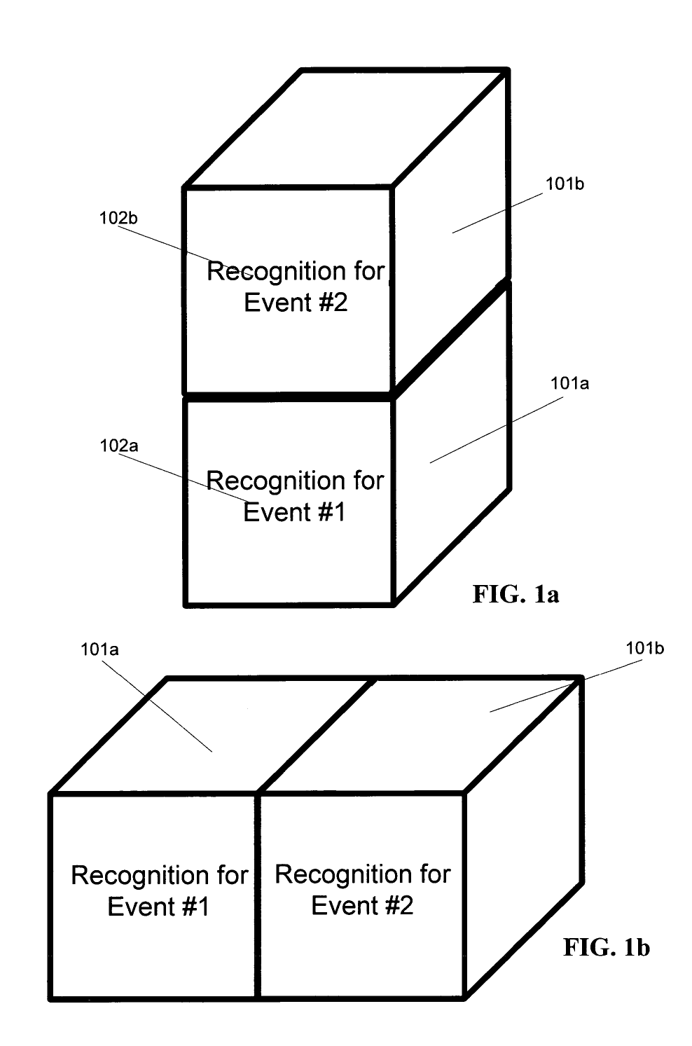

In an embodiment shown in FIG. 1a, recognition elements 101a and 101b may be given to an individual, group, or team in recognition of an award, reward, achievement, designation, distinction, or participation. For example, recognitions may be given for school awards (e.g., from kindergarten to graduate school), for business related accomplishments (e.g., from a company or a professional association), for recreational activities (e.g., team or individual sports), for individual accomplishments (e.g., to a child who has completed all of his/her chores for the week), and other accomplishments. Other reasons for giving recognition elements are also contemplated. In various embodiments, successive recognition elements may be arranged relative to each other to show a progressive and/or cumulative relationship. Recognition elements 101a and 101b may be in numerous shapes and sizes and may be formed from various materials. For example, recognition elements 101 may be cubic elements (as depicted in FIGS. 1a and 1b). In some embodiments, the recognition elements 101 may be made of plastic, wood, stone, metal, etc. Other materials for the recognition elements 101 are also contemplated. In addition, recognition elements 101 may contain text 102a and 102b to describe the recognition given. In various embodiments, a mixture of text, symbols, figures, and/or images may be on one or multiple surfaces of the recognition elements. For example, if the recognition is the completion of a business project phase, the textual recognition 102 may read “Congratulations for Completing Phase 1!” Other recognitions are also contemplated. In various embodiments, the textual recognitions 102 may be marked, engraved, or embossed. Other techniques for displaying textual recognitions 102 are also contemplated. In addition, the recognition elements may be marked, engraved, or embossed with symbols (e.g., company logos), figures, and/or images (e.g., images of people or objects).

The recognition elements 101 may be arranged in various shapes or forms. In some embodiments, the recognition elements 101 may be arranged in a form chosen by the recipient of the recognition elements 101. As shown in FIG. 1a, the recognition elements 101 may be stacked on top of each other. In various embodiments, the recognition elements may be self-standing. As shown in FIG. 1b, the recognition elements may be placed side by side. In various embodiments, various combinations of stacked recognition elements and side-by-side recognition elements may be used to form various shapes to represent cumulative achievements. In some embodiments, the recognition elements may be rearranged by the recipient to allow for a dynamic cumulative recognition. In various embodiments, the recognition elements 101 may be placed in a readily viewed area by the recipient. For example, the recognition elements 101 may be placed on a desk at work, on a shelf at home, or in some other area chosen by the recipient. In an embodiment, the area may be designated by the entity giving the recognition elements 101. For example, a company may ask that all employees display their recognition elements on the right edge of their desks. Other employees may then know where to look upon entering an employee's office to see his/her recognition elements 101 reflect his/her level of cumulative recognition or contribution.

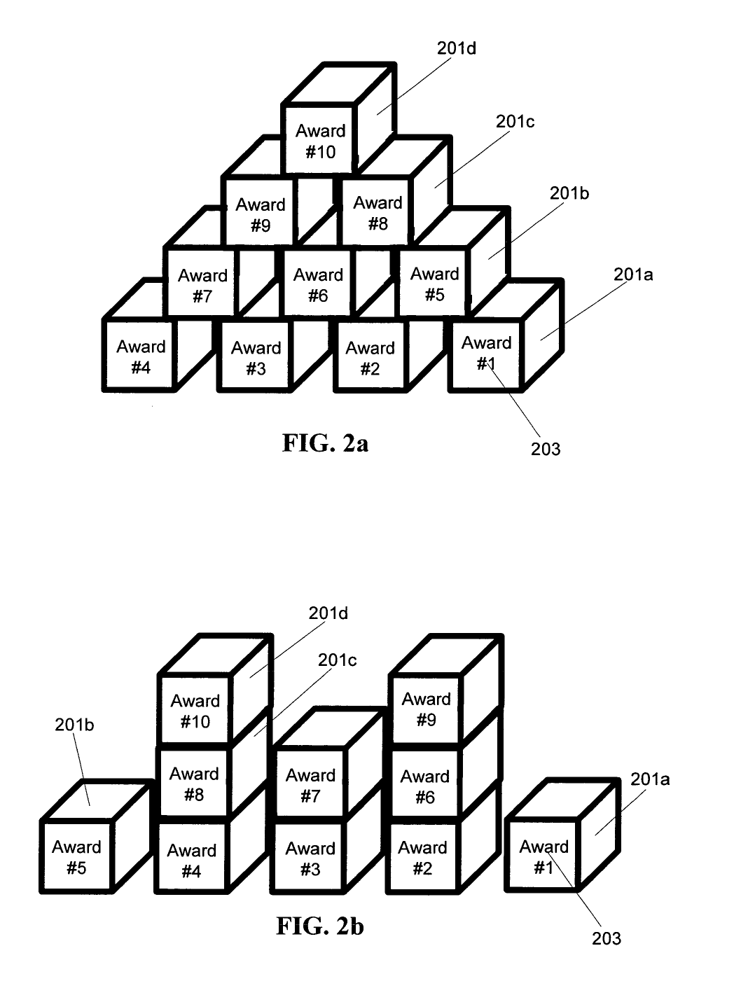

In addition, various numbers of recognition elements 101 may be awarded. For example, the embodiments in FIGS. 1a and 1b show two recognition elements 101. In various embodiments, such as, but not limited to, the embodiments shown in FIGS. 2a and 2b, multiple recognition elements 101 may be awarded. As a recipient is awarded recognition elements 201, the recognition elements 201 may be arranged in predetermined forms or in any form desired by the recipient to create a unique form (e.g., a pyramid form as depicted in FIG. 2a.) In some embodiments, as a recipient receives additional recognition elements, the recognition elements may be arranged into a different shape. If the recognition elements 201 are placed in predetermined forms, the recognition elements 201 may be designed such that the most significant recognition element is placed at a specific location (e.g., the top of the pyramid). In some embodiments, the final form of the recognition elements 201 may signify a cumulative accomplishment (e.g., an employee with a complete pyramid form may be recognized as having provided significant revenue to the company). In some embodiments, the recognition elements 201 may be placed in an arbitrary form or a form chosen by the recipient of the recognition elements 201 (such as, but not limited to the stair-step form in FIG. 2b). By allowing each recipient to arrange the elements in his/her selected fashion, the recipient's creativity may be used to personalize the cumulative representation of their accomplishments. The recipient may also rearrange the elements as desired over time allowing for a dynamic appearance.

As shown in FIG. 2a and 2b, a textual recognition 203 may be included on at least one surface of the recognition element. In an embodiment, a textual recognition 203 may be included on other surfaces of the recognition elements 201. In addition, the recognition elements 201 may be different colors or materials (e.g., different colors may represent different levels of recognition. For example, a gold recognition element may be more difficult to achieve than a silver recognition element. In various embodiments, recognition elements 201 of different colors, shapes, and/or materials may be used together.

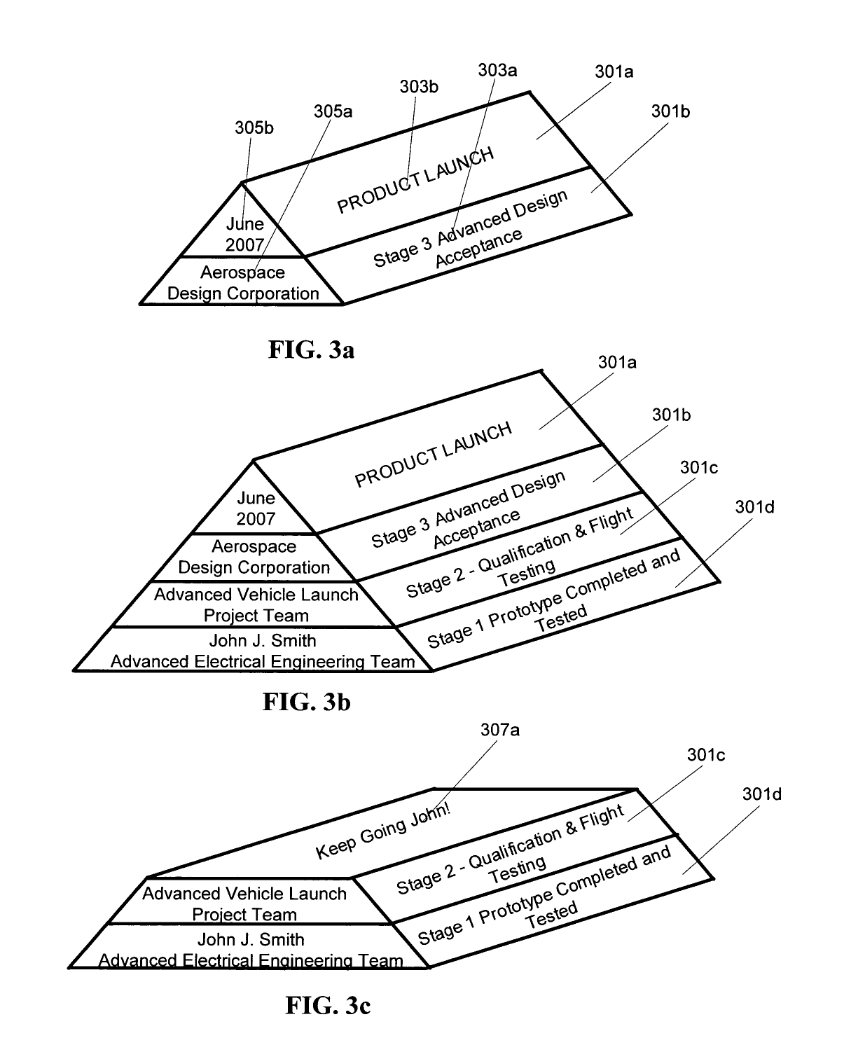

As seen in FIGS. 3a, 3b and 3c, the recognition elements may be in shapes that together will form a predetermined form (e.g., the recognition elements in FIG. 3, when assembled together may form a pyramid). Also, any number of recognition elements 301 may be used. For example, two recognition elements 301 are shown to form a pyramid in FIG. 3a. In the embodiment shown in FIG. 3b, four recognition elements 301 are shown forming a pyramid. In an embodiment, as seen in FIG. 3c, textual recognition 305 may be included on multiple surfaces of the recognition element 301. Also, as seen in FIG. 3c, textual recognition, such as, but not limited to, encouragement textual recognition 307, may be included on a top surface of the recognition element 301. In an embodiment, the top surface may be covered by subsequent recognition elements 301. In this embodiment, the textual recognition on the top surface of the underlying recognition element 301c may no longer be relevant when a subsequent recognition element 301b is awarded. In addition, each layer of the pyramid may represent a more significant recognition than lower layers (e.g., some people at a company may never complete the pyramid). In an embodiment, the pyramid recognition elements 301 may represent different phases of a project that the recipient is working on. In an embodiment, the different pyramid recognition elements 301 may represent different levels of progress achieved by the recipient. Other uses for the recognition elements 301 are also contemplated. As discussed with FIG. 1, the recognition elements 301 may be awarded to an individual, group or team to recognize different achievements and may be used to signify progressive and/or cumulative achievements.

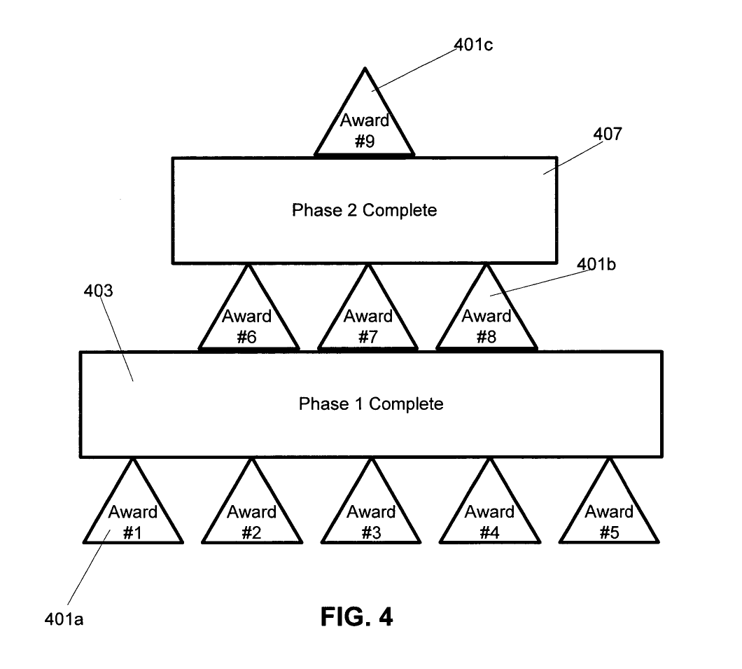

As shown in FIG. 4, different recognition element shapes may be used for a predetermined form. In an embodiment, triangular recognition elements 401 may be used to represent different achievements on a similar level. The rectangular recognition elements 403 may be used to represent different levels and may be harder to achieve. For example, a child may be awarded a triangular recognition element 401 each week the child completes all of the child's assigned chores for the week. If the child receives a certain amount of triangular recognition elements 401 in a given time frame, the child may receive a rectangular recognition element 403 to rest on top of the other triangular elements. In an embodiment, the rectangular recognition elements 403 and 405 may be as difficult to acquire as the triangular recognition elements 401, and may be given at a certain point to allow the predetermined form to be organized.

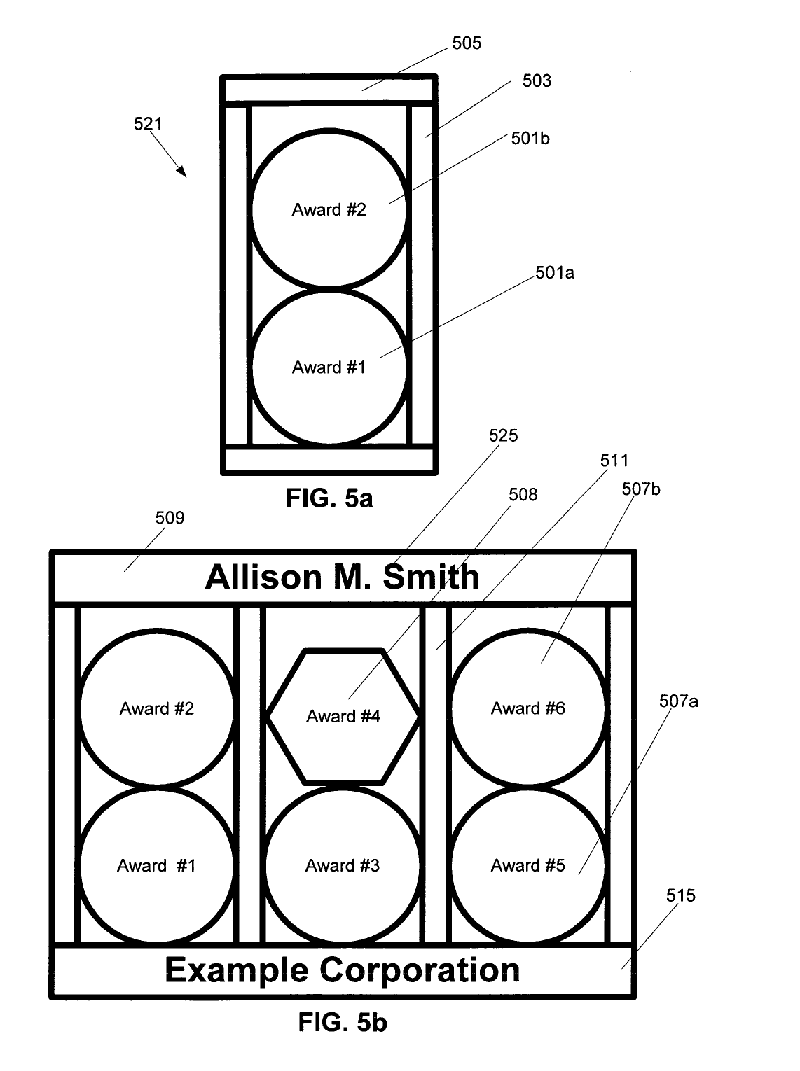

As shown in FIGS. 5a and 5b, a retention structure may be used in conjunction with the recognition elements to organize the recognition element into a predetermined form and/or facilitate their stacking. In some embodiments, the rectangular retention structure 521 may be given as a first recognition. The retention structure may be marked, engraved, or embossed 525 to be personalized to the recipient. In an embodiment, the rectangular retention structure 521 may be given at the outset of a project. As recognition elements 501 are accumulated, the recognition elements 501 may be placed into the rectangular retention structure 521. In some embodiments, the recognition elements 501 may be cylindrical recognition elements. In an embodiment, a circular end of the cylindrical recognition elements may be visible through a rectangular face of the rectangular retention structure 501. In various embodiments, recognition elements 501 may be placed onto previous recognition elements 501 received. In some embodiments, the rectangular retention structure 521 may be expandable to add other units for future recognition elements 501. In addition, different shaped recognition elements 508 may be placed in the same retention structure 521. In various embodiments, different shapes, materials, and/or different colors may be used to represent different levels of achievement. In some embodiments, the rectangular retention structure 521 may be designed to accommodate different sizes of recognition elements 501. In addition, different parts of the rectangular retention structure 521 may be given as recognition elements. For example, the bottom part 515 of the rectangular retention structure 521 may be given first, followed by several recognition elements 501, and finally by the top 509 of the retention structure as a final recognition element. Other retention structures and recognition elements are also contemplated.

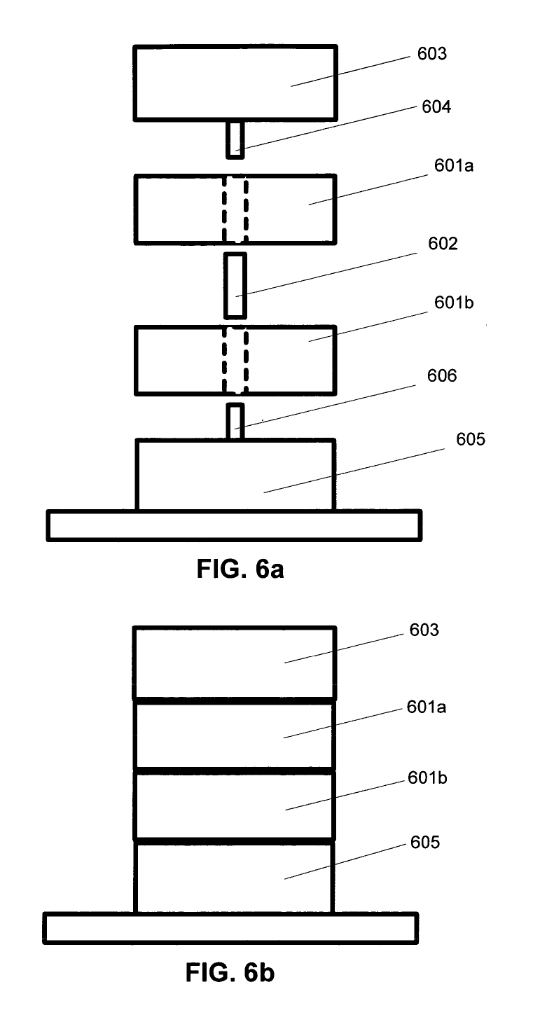

As shown in FIGS. 6a and 6b, the recognition elements may have a hole for a corresponding support or rod. In some embodiments, the hole may run down the center of the recognition elements (e.g., for a rod that may run through the holes on corresponding recognition elements). In some embodiments, the hole may be in a different location on the recognition elements. In addition, the hole may not go all the way through the recognition elements. In an embodiment, a lower retention structure element 605 may have a support 606 through part of the bottom of a first element 601b. In an embodiment, a rod 602 may be used through part of the top of the first element 601b and part of the bottom of the second element 601a. In some embodiments, the recognition elements 601 may be in the form of cylindrical recognition elements (as depicted in FIGS. 6a and 6b) with a hole on at least one of the faces of the cylindrical recognition element to fit a corresponding support from a cylindrical recognition element above. In an embodiment, the support 606 may be on a top face of a recognition element and fit a hole in the bottom face of a element stacked on top. In some embodiments, the support 606 may be off of the center of the recognition elements. In addition, the base of the recognition elements may have a hole to receive the support 606 of the first recognition element. In some embodiments, the recognition elements may be continuously added onto.

In an embodiment, the base may support a rod running through the center of each recognition element. In this embodiment, each recognition element may have a hole running down the center. In an embodiment, each recognition element may represent a cumulative achievement. A top element or retention structure cap may be used on top of the rod. Also, in this embodiment, the top element may be awarded last as a final achievement. In another embodiment, the top element may be given with the rest of the retention structure (e.g., at the beginning of a project).

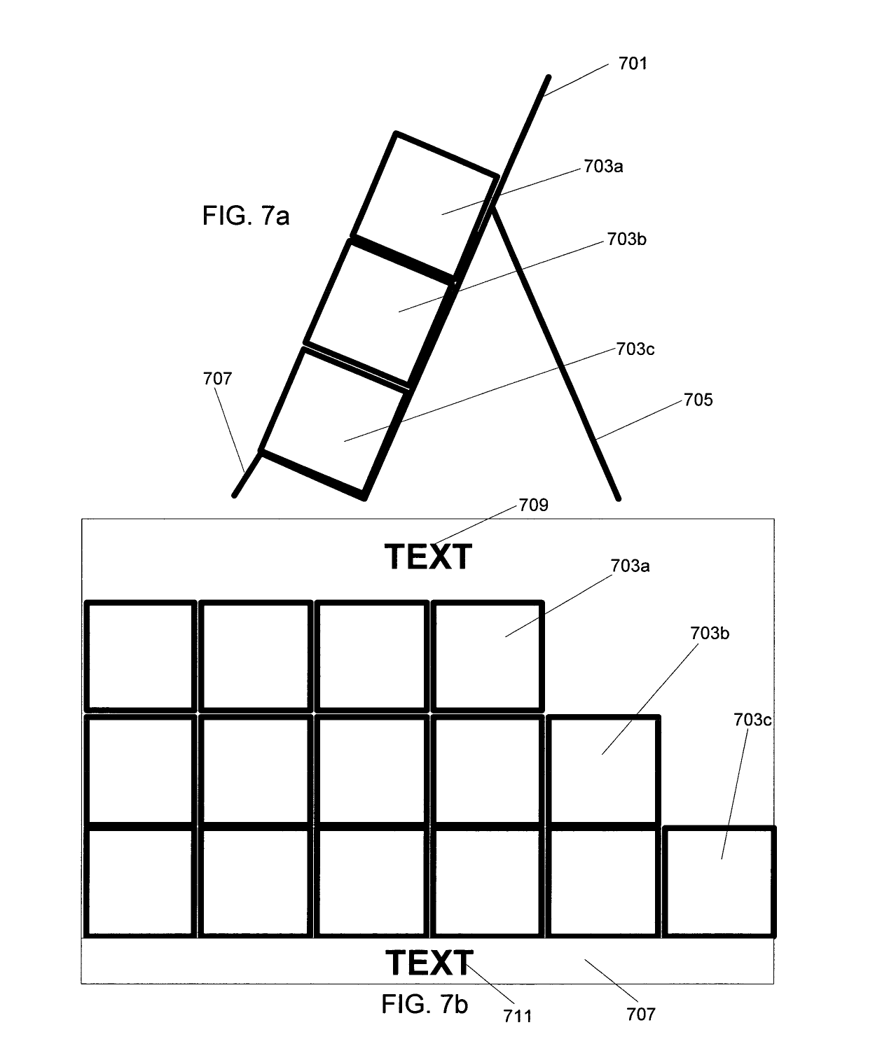

As shown in FIGS. 7a and 7b, an embodiment may include a retention structure 701 for placing recognition elements 703. In some embodiments, the recognition elements 703 may be sized to stack on top of one another. In an embodiment, the retention structure 701 may be a slanted back plate with support 705. As recognition elements 703 are collected, they may be stacked on top of each other and displayed at an angle. In various embodiments, the retention structure 701 may have a lower lip 707 for additional text 711. Additional text 709 may also be placed at the top of the retention structure 701. In some embodiments, each recognition element 703 may have writing on one or more than one surface of the recognition elements 703. In some embodiments, the recognition elements 703 may spell out a final achievement when all of the recognition elements 703 are awarded and placed. In various embodiments, the recognition elements 703 may be different colors and/or materials. The different colors may combine to form a final image when all of the recognition elements 703 are awarded and placed. Other retention structures and recognition elements are also contemplated.

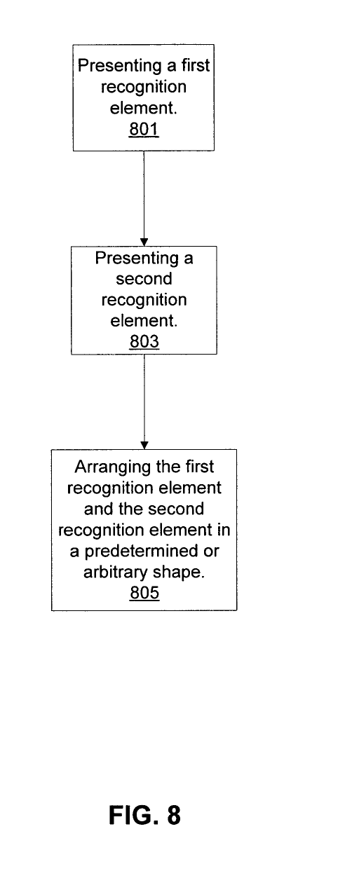

Referring to FIG. 8, a flowchart of an embodiment of a method for presenting cumulative recognition elements is shown. It should be noted that in various embodiments of the methods described below, one or more of the processes described may be performed concurrently, in a different order than shown, or may be omitted entirely. Other additional processes may also be performed as desired.

At 801, a first recognition element may be presented. In various embodiments, the recognition element may be presented to an individual, group, or team. The first recognition element may be given to represent an achievement. For example, the first recognition element may be awarded to an employee by a company for completing a certain phase of a project. In an embodiment, the first recognition element may be awarded to a child by a parent for getting good grades in school.

At 803, a second recognition element may be presented. In some embodiments, the second recognition element may be associated with the first recognition element. For example, the first recognition element and the second recognition element may represent a progressive or cumulative achievement.

At 805, the first recognition element and the second recognition element may be arranged in a predetermined or arbitrary form. In various embodiments, the first recognition element and the second recognition elements may be placed into a retention structure (e.g., a retention structure). In some embodiments, textual recognition may also be added to the first recognition element and the second recognition elements.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system, comprising:
at least one first recognition element; and
at least one second recognition element;
wherein, in combination, at least one first recognition element and at least one second recognition element interrelate to form a combined recognition structure.

2. The system of claim 1, wherein at least one first recognition element and at least one second recognition element are stackable to form the combined recognition structure.

3. The system of claim 1, wherein a portion of at least one first recognition element is supported by a portion of at least one second recognition element to form the combined recognition structure.

4. The system of claim 1, wherein the combined recognition structure comprises a predetermined shape.

5. The system of claim 1, wherein the combined recognition structure comprises a predetermined number of recognition elements.

6. The system of claim 1, wherein the combined recognition structure comprises an arbitrary shape.

7. The system of claim 1, wherein the combined recognition structure is self-standing.

8. The system of claim 1, wherein at least one first recognition element and at least one second recognition element have different shapes.

9. The system of claim 1, further comprising at least one retention structure, wherein at least one first recognition element and at least one second recognition element are placed relative to each other in the at least one retention structure to form the combined recognition structure.

10. The system of claim 9, wherein at least one recognition element is a cylinder and wherein at least one retention structure comprises a slot for receiving the cylinder.

11. The system of claim 9, wherein at least one recognition element is a cylinder having at least one hole in a part of the cylinder and wherein at least one retention structure comprises a rod to engage at least one hole in the cylinder when the cylinder is placed on the rod.

12. The system of claim 9, wherein at least one recognition element is a cube and wherein the retention structure is a slanted back plate for receiving the cube to display the cube at an angle.

13. The system of claim 9, wherein the combined recognition structure is expandable.

14. The system of claim 1, wherein at least one first recognition element comprises a textual recognition, and wherein the combined recognition structure is configured such that at least one textual recognition is visible when the combined recognition structure is formed.

15. The system of claim 1, wherein at least one first recognition element comprises a textual recognition, and wherein the combined recognition structure is configured such that at least one textual recognition is not visible when the combined recognition structure is formed.

16. The system of claim 1, wherein at least one first recognition element further comprises a symbol, figure, or image.

17. The system of claim 1, wherein the first recognition elements and the second recognition elements have approximately the same shape.

18. The system of claim 1, wherein at least one first recognition element or at least one second recognition element has markings to indicate a specific recognition.

19. The system of claim 1, wherein the combined recognition structure comprises a pyramid.

20. The system of claim 1, wherein at least one first recognition element and at least one second recognition element are each selected from a set of recognition element shapes configured to interact with one another to form the combined recognition structure.

21. The system of claim 1, wherein at least one recognition element is a cube and the combined recognition structure is in the form of a pyramid.

22. A method, comprising:
providing at least one first recognition element;
providing at least one second recognition element, arranging at least one first recognition element relative to at least one second recognition element to form a combined recognition structure.

23. The method of claim 22, further comprising:
adding textual recognition to a surface of at least one first recognition element.

24. The method of claim 22, further comprising:
adding textual recognition to a surface of at least one second recognition element.

25. The method of claim 22, further comprising:
wherein the combined recognition structure comprises a predetermined form.

26. The method of claim 22, further comprising:
wherein arranging at least one first recognition element relative to at least one second recognition element to form the combined recognition structure comprises arranging at least one first recognition element and at least one second recognition element relative to each other in a retention structure.

27. The method of claim 22, wherein at least one first recognition element and at least one second recognition element are provided in response to cumulative accomplishments.

28. The method of claim 22, wherein providing at least one first recognition element and providing at least one second recognition element comprises selecting at least one first recognition element and at least one second recognition element from a set of recognition element shapes configured to interact with one another to form the combined recognition structure.

29. The method of claim 22, wherein providing at least one first recognition element is in response to completion of a project phase and wherein the combined recognition structure represents multiple completed project phases.

30. The method of claim 22, wherein providing at least one first recognition element is in response to an athletic accomplishment and wherein the combined recognition structure represents multiple interrelated athletic accomplishments.
